(19) United States
(12) Patent Application Publication
(10) Pub. No.: US 2026/0184630 A1
(43) Pub. Date: Jul. 2, 2026

(54) CALCIUM SULFOALUMINATE (CSA) CEMENT CLINKER WITH CALCIUM MAGNESIUM SILICATE

(71) Applicant: CemVision AB, Stockholm (SE)

(72) Inventors: Claes Göran Kollberg, Mörbylånga (SE); Paul Johan Sandberg, Nokomis, FL (US)

(21) Appl. No.: 19/545,769

(22) Filed: Feb. 20, 2026

Related U.S. Application Data
(63) Continuation of application No. PCT/IB2024/058323, filed on Aug. 27, 2024.
(60) Provisional application No. 63/535,570, filed on Aug. 30, 2023.

(51) Int. Cl. C04B 7/147; C04B 7/44

(52) U.S. Cl. CPC C04B 7/147; C04B 7/44

(57) ABSTRACT

A cementitious mixture comprising calcium magnesium silicates is disclosed. In one embodiment, the cementitious mixture may be a calcium sulfoaluminate cement clinker formed of at least 60% by weight of industrial byproducts. The cementitious mixture may have a calcium magnesium silicate content of at least 10% by weight and may demonstrate reduced carbon emissions compared to CSA cement clinkers having little to no magnesium content.

### CROSS-REFERENCE TO RELATED APPLICATIONS

This application is a continuation of International Patent Application No. PCT/IB2024/058323, entitled “CALCIUM SULFOALUMINATE (CSA) CEMENT CLINKER WITH CALCIUM MAGNESIUM SILICATE” and filed Aug. 27, 2024, which claims the benefit of U.S. Provisional Patent Application No. 63/535,570, entitled “CALCIUM SULFOALUMINATE (CSA) CEMENT CLINKER WITH CALCIUM MAGNESIUM SILICATE” and filed Aug. 30, 2023. The entire contents of each of the above-identified applications are hereby incorporated by reference for all purposes.

### FIELD

Embodiments of the subject matter disclosed herein relate to cementitious materials and processes for forming cement for concrete components, and more particularly to systems and methods for cement clinkers with calcium silicate compositions.

### BACKGROUND

Cement is widely used in construction and its production relies on a combination of minerals. As construction relying on concrete components is increasing globally, consumption of cement has accelerated over recent years. The production of cement, however, releases carbon dioxide. Approaches to decrease the carbon footprint of cement production suffer from various constraints. Some techniques, for example, are constrained by the formation of reaction products that degrade the mechanical properties of the resulting cement.

### BRIEF DESCRIPTION OF THE DRAWINGS

Various embodiments and techniques will be described with reference to the drawings, in which:

FIG. 1 shows a simplified process for forming a cement clinker according to an embodiment of the present disclosure;

FIG. 2 shows a method for cement clinker production, according to an embodiment of the present disclosure;

FIG. 3 shows a graph depicting EN 196 compressive strength development of a cement clinker ground with calcium sulfate over time, according to an embodiment of the present disclosure; and

FIG. 4 shows a graph depicting a reaction rate of belite and bredigite (a magnesium silicate) measured by quantitative XRD using the Rietveld Refinement method in cement paste over time, according to an embodiment of the present disclosure.

### DETAILED DESCRIPTION

Calcium sulfoaluminate (CSA) cements are a class of cement comprising ye'elimite (anhydrous calcium sulfoaluminate, also referred to as Klein's compound) as the principal mineral providing strength and other mechanical properties when mixed with water and aggregates to form mortars and concrete. CSA cements are known to have lower carbon emissions than traditional cementitious materials, such as Portland cement. During heating/calcination of raw materials to facilitate a high temperature sintering process that leads to formation of cement clinker, the clinker being a nodular material that is ground and mixed with calcium sulfate and other materials to form cement, the conversion of limestone (CaCO₃) to lime (CaO) releases carbon dioxide. Use of fossil fuels to provide the energy for calcination may further contribute to the carbon footprint of cement manufacturing. For CSA cements, less limestone is incorporated into its composition relative to Portland cement, and calcination and/or sintering to form CSA cement clinker is performed at lower temperatures, thereby lowering its specific energy requirements for production.

The carbon footprint of cement production may be further decreased by incorporating industrial byproducts into the raw material used to form the clinker. For instance, slag generated during metallurgical smelting may be used in the clinker production to at least partially substitute for limestone or other typical raw materials such as natural clays or sand. The amount of industrial byproducts that is used in cement is constrained, however, by production cost, presence of undesirable elements, and the technical performance of the resulting cement. For example, industrial byproducts with high aluminum oxide (Al₂O₃) content may be favored as a replacement for bauxite in CSA cement clinkers over byproducts with low aluminum content. Further, low levels of magnesium in the byproducts may be desirable to minimize formation of magnesium oxide during the clinker manufacture, which may otherwise lead to a loss of strength in the finished cement that is caused by the hydration of magnesium oxide.

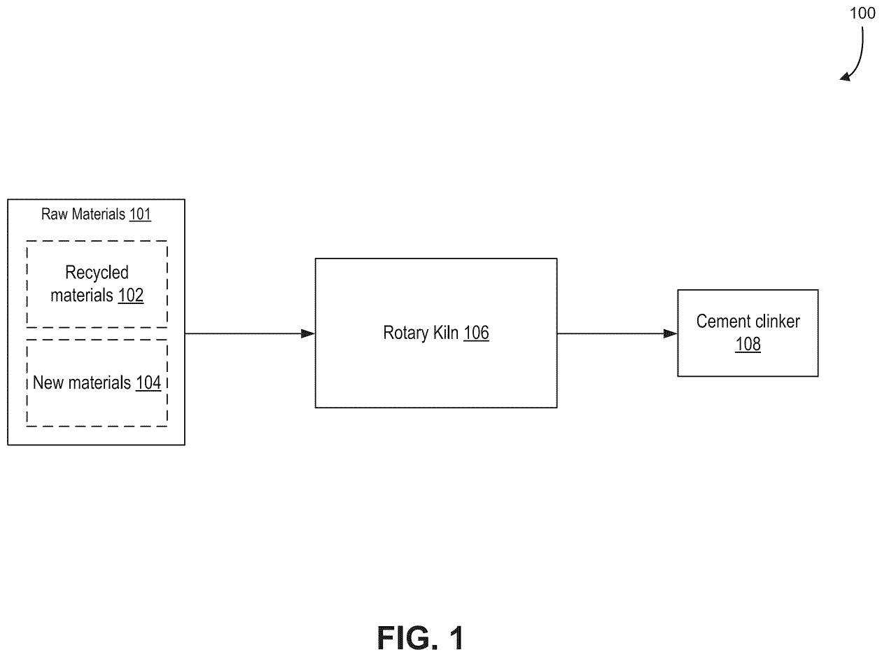

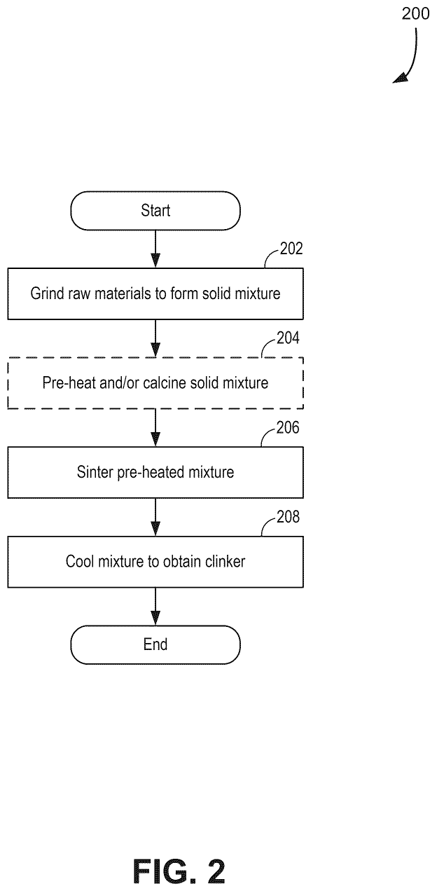

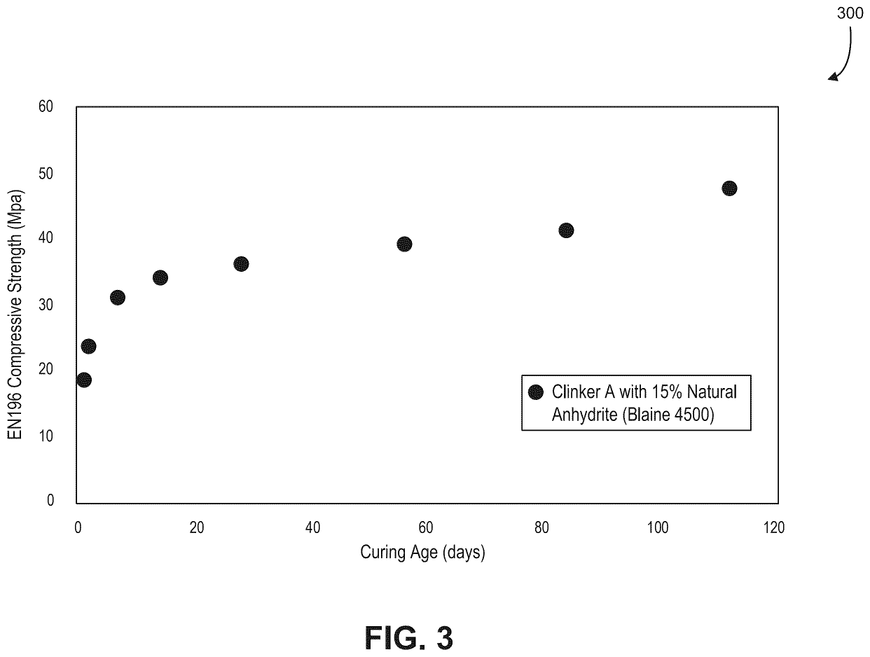

In some embodiments, as described herein with reference to FIGS. 1 and 2, the presence of magnesium in industrial byproducts, such as slag generated during steel fabrication, may be leveraged to produce a CSA cement clinker comprising calcium magnesium silicates. The formation of calcium magnesium silicates may reduce the amount of magnesium oxide formed in the clinker, thereby mitigating any expansion caused by the hydration of magnesium oxide which may otherwise degrade the strength (e.g., resistance to compression) of the resulting cement. In contrast, the presence of the calcium magnesium silicates in the clinker may, in some cement formulations, provide a strength benefit arising from cementitious calcium magnesium silicate hydration. The resulting cement does not demonstrate detrimental expansion or loss of compressive strength when tested in cement mortar or concrete for up to 240 days, as shown further in FIG. 3 and Table 2. The cement clinker may be formed via a calcination process that promotes the formation of various calcium magnesium silicate phases, such as bredigite, merwinite, and åkermanite-gehlenite solid solutions, while suppressing the amount of magnesium oxide generated (and hence the formation of magnesium hydroxide by reaction with water, a reaction which is associated with deleterious expansion if the content of magnesium oxide in the cement exceeds a threshold of 5% or 6%).

By enabling the formation of non-deleterious and optionally cementitious calcium magnesium silicates during clinker formation, the constraints on amounts of industrial byproducts used in cement production may be eased. In one embodiment, the raw materials used to form a CSA cement clinker may comprise at least 70% by weight of industrial byproducts. In another embodiment, the CSA cement clinker may comprise greater than 90% by weight of industrial byproducts. The industrial byproducts may be obtained from mining and metallurgical industries which maximizes the circularity, e.g., incorporation of recycled materials, of the CSA cement clinker while reducing carbon emissions by greater than 70%, in one embodiment, and preferably by greater than 90%, in another embodiment. In yet another embodiment, carbon emissions may be reduced by 100% during production of the CSA cement clinker. In other words, in some embodiments, no fossil carbon is released during production of the CSA cement clinker when the required thermal energy is provided without using fossil fuel.

Turning to FIG. 1, an example of a simplified process 100 for cement clinker production is shown. In particular, the simplified process 100 may provide a CSA cement clinker comprising calcium magnesium silicates. Details of raw materials used in the process 100, heating of the raw materials in a rotary kiln and a composition of a resulting cement clinker are elaborated further below. In the simplified process 100, a mixture of raw materials 101, including recycled materials 102 and new materials 104, may be added to a rotary kiln 106. It will be appreciated the simplified process 100 is a non-limiting example and the process for forming a cement clinker may include various steps in addition to those depicted in FIG. 1, which are omitted for brevity. The recycled materials 102 may include various types of industrial byproducts, including but not limited to byproducts of mining and metallurgical processes. The new materials 104 may be virgin raw materials including but not limited to limestone, bauxite, and gypsum.

A proportion of the recycled materials 102 and the new materials 104 may be varied relative to one another in an inverse manner. For example, as the amount of recycled materials 102 increases, the amount of the new materials 104 may decrease. In one embodiment, increasing the amount of recycled materials may proportionally decrease the amount of the new materials used to form a cement clinker 108. As an example, by increasing the amount of recycled materials 102 by 40%, the amount of new materials may be decreased by 40%.

In the rotary kiln 106, the raw materials 101 may be mixed therein while being heated to a target temperature for a threshold period of time to calcinate the raw materials 101. In one embodiment, the heating may be conducted according to a predefined heating profile. When heating is complete, the rotary kiln 106 may be cooled and the cement clinker 108 may be obtained as a nodular or granular mixture of minerals.

An example of a method 200 for forming a CSA cement clinker comprising calcium magnesium silicates is depicted in FIG. 2. The method 200 may be performed at a manufacturing facility using suitable equipment and machinery for implementing the steps included in method 200. The equipment and machinery, as well as other operations facilitating cement clinker manufacturing may rely on automated processes, manual processes, or a combination thereof.

At block 202, the method 200 may include grinding raw materials to form a homogeneous solid mixture. The raw materials, as described above, may include new materials (e.g., virgin materials) and recycled materials. The recycled materials may incorporate various industrial byproducts, such as metallurgical and mining slags. In one embodiment, the recycled material may include magnesium minerals. The new materials may comprise minerals with high aluminum content, as well as minerals that promote desirable reactions for forming the clinker and impart the mixture with target mechanical and chemical properties. In an embodiment, the raw materials may be ground in a mill to reduce a particle size of the raw materials and homogenize the solid mixture.

At block 204, the method 200 may include pre-heating and/or calcining the solid mixture. In some embodiments, pre-heating and/or calcining the solid mixture may be optional. For example, as an amount of carbonated or hydroxylated materials decreases in the solid mixture, a benefit or demand for preheating and/or calcining may diminish accordingly. In one embodiment, the solid mixture may comprise no carbonated or hydroxylated materials which may lead to more efficient heat distribution. By increasing the efficiency of heat distribution, production efficiency may be increased and/or shorter kiln processing may be allowed, which in turn may lead to reduced capital and operational costs. The solid mixture may be pre-heated, in one embodiment, by heating the solid mixture in a suspension or cyclone pre-heater, which may flow heated air through the solid mixture as the solid mixture passes through the pre-heater. Pre-heating may calcine the solid mixture and reduce a temperature differential between the solid mixture and a rotary kiln in which sintering of the solid mixture is to be conducted. This may increase the efficiency of the rotary kiln operation and decrease the required retention time to complete the sintering process, thereby reducing energy consumption.

At block 206, the method 200 may include sintering the pre-heated and/or calcinated solid mixture. In one embodiment, as described above, the solid mixture is sintered with reduced or no pre/heating and/or calcining. As an embodiment, the pre-heated solid mixture may be added to a kiln and heated to a target temperature. Various types of kilns may be used, including rotary kilns and shaft kilns. The heating to the target temperature may follow a predetermined heating profile and/or a predetermined heating rate to cause reactions forming desired clinker minerals to occur. The reactions may include evaporation of moisture, dehydration, decomposition of minerals, and solid-phase interactions. In addition, in one embodiment, the solid mixture may be heated to a temperature that promotes formation of a liquid phase that is thermodynamically favorable for formation of calcium magnesium silicate phases.

At a peak temperature of the sintering process, CSA clinker phases and other, more common cementitious phases such as alite may be formed, along with a complex liquid phase. After reaching the peak temperature, the method 200 may include cooling the kiln at block 208 at a rate that results in a desired granularity and mineralogical composition of the cement clinker.

### Raw Materials for CSA Cement Clinker

As described above with reference to FIG. 1, raw materials used to form the clinker may include a mixture of recycled materials and new materials. The recycled materials may include various industrial byproducts, such as ladle slag from steel-making processes, slag from other mining and metallurgical industries, various types of combustion residues such as fly ash, desulfurization lime, and natural anhydrite. Further, the raw materials may include elements commonly represented as oxides such as, but not limited to, silicon dioxide [SiO₂], aluminum oxide [Al₂O₃], iron oxide [Fe₂O₃], calcium oxide [CaO], magnesium oxide [MgO], sulfur trioxide [SO₃], sodium oxide [Na₂O], potassium oxide [K₂O], phosphorous pentoxide [P₂O₅], titanium dioxide [TiO₂], manganese (III) oxide [Mn₂O₃], manganese (II, III) oxide [Mn₃O₄], and strontium oxide [SrO].

### Sintering of Raw Materials

The raw materials may be heated in the rotary kiln to a temperature and with a composition that minimizes the formation of MgO. In one embodiment, the sintering of the raw materials may be conducted at a temperature range of 1220° C. to 1280° C., inclusive, although temperatures above or below this range are possible. The temperature of sintering may be a temperature that promotes formation of calcium magnesium silicates, including, but not limited to, bredigite [Ca₁₄Mg₂(SiO₄)₈], merwinite [Ca₃Mg(SiO₄)₂], and åkermanite-gehlenite solid solutions. In one embodiment, the raw materials may be heated to a temperature during sintering that causes formation of a liquid phase that favors stabilization of the calcium magnesium silicates over magnesium oxide during cooling. By promoting the formation of the calcium magnesium silicates, an amount of magnesium oxide formed in the clinker may be reduced.

### Clinker Composition

In an embodiment, the clinker formed via the process shown in FIG. 1 and using the raw materials and calcination parameters described above may comprise ye'elimite [Ca₄Al₆O₁₂SO₄ cubic and/or orthorhombic] and other calcium aluminate phases such as mayenite [C₁₂Al₁₄O₃₂₊ₓ which may contain Cl, F and OH as stabilizing agents] and Ca₃Al₂O₅, together with silicates such as belite [β-Ca₂SiO₄ and/or α′-Ca₂SiO₄], gehlenite [Ca₂Al[AlSiO₇]] and åkermanite [Ca₂Mg[Al₂O₇]] or more generally the melilite solid solution, periclase [MgO], lime [CaO], magnetite [Fe₃O₄], perovskite [CaTiO₃], calcium sulfate anhydrite [CaSO₄], bredigite [Ca₇MgSi₄O₁₆], merwinite [Ca₃MgSi₂O₈], brownmillerite [Ca₂(Al,Fe)₂O₅] and spinel [MgAl₂O₄] as well as other minerals. In another embodiment, the clinker may include alite [monoclinic, triclinic or rhombohedral Ca₃SiO₅] in addition to ye'elimite. An exemplary composition of the clinker is shown below in Table 1.

TABLE 1
Example of CSA clinker A mineralogy measured by QXRD.

| Mineral | Weight % |
|---|---|
| Ye'elimite | 45.3 |
| Belite | 9.6 |
| Mayenite | 1.0 |
| Gehlenite | 2.8 |
| Periclase | 4.0 |
| Magnetite | 0.6 |
| Perovskite | 2.9 |
| Merwinite | 2.2 |
| Bredigite | 31.1 |

A robustness of a cement formed from a clinker incorporating calcium magnesium silicate phases may be assessed according to ASTM C151 autoclave expansion tests. For example, undesirable expansion of a hydraulic cement over a period of time may be observed and quantified via the expansion tests. Results of the ASTM C151 test performed on four cements incorporating different clinker compositions are shown in Table 2. The cements are formed by intergrinding a mixture composed of 85% clinker with 15% natural anhydrite (CaSO₄) by weight, to a Blaine fineness of 4500. A total MgO content shown in Table 2 was determined by XRF and the remaining mineral phases were measured by QXRD using the Rietveld Refinement method.

TABLE 2
Examples of CSA clinker compositions by weight % and ASTM C151
autoclave expansion test results of corresponding cements.

| | | | | | | | MgO | ASTM |
|---|---|---|---|---|---|---|---|---|
| | Total | MgO | Mer- | | MgO | MgO | (other | C151 |
| Clinker | MgO | (Periclase) | winite | Bredigite | (Merwinite) | (Bredigite) | phases) | expansion |
| A | 6.65 | 3.98 | 2.18 | 31.1 | 0.27 | 1.85 | 0.55 | pass |
| B | 6.32 | 4.86 | 3.74 | 12.2 | 0.46 | 0.73 | 0.28 | pass |
| C | 6.61 | 6.12 | 0.34 | 3.37 | 0.04 | 0.20 | 0.25 | fail |
| D | 7.36 | 6.88 | 0.93 | 1.28 | 0.11 | 0.08 | 0.29 | fail |

The results shown in Table 2 indicate that clinkers with elevated merwinite and bredigite phases expand less than clinkers with lower merwinite and bredigite phases. Moreover, despite similar overall MgO content among the clinkers, the MgO in clinkers with higher merwinite and bredigite content result in a higher proportion of MgO phases being associated with merwinite and bredigite, which yield cements less prone to expansion.

A compressive strength development of clinker A of Table 2, ground with 15% by weight of natural anhydrite, is depicted in FIG. 3 in graph 300. The compressive strength of clinker A, in MPa, is plotted along the ordinate relative to curing age, in days, along the abscissa. Measurements displayed in graph 300 demonstrate continued strength development after 20 days, despite ye-elimite being a fast-reacting mineral that is not expected to strength development beyond 20 days. The results indicate that expansion is absent, as confirmed by the result of the ASTM C151 autoclave expansion test shown in Table 1, and that magnesium silicate phases in clinker A are reacting and contributing to a long term strength development and durability of the cementitious product.

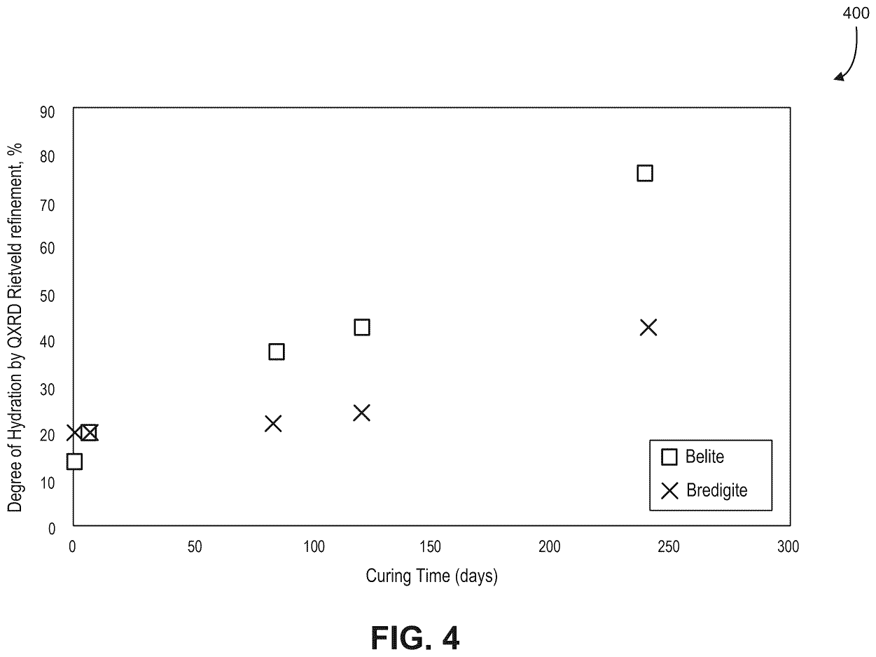

Further experimental results are shown in FIG. 4 in graph 400 which depicts a degree of hydration of belite and bredigite over a period of curing. The results shown in graph 400 indicate that bredigite continues to react over time during curing, similar to belite. Hydration of bredigite in clinker A is measured by QXRD using the Rietveld Refinement method over a curing period of up to 250 days. During the initial 120 days, over which the compressive strength development of clinker A increases as depicted in graph 300 of FIG. 3, the degree of hydration of bredigite also increases. After 120 days of curing, the degree of hydration of bredigite continues to increase and is nearly doubled by 250 days (e.g., the degree of hydration increases from approximately 23 at 120 days to over 40 by 250 days of curing). The continued reactivity of bredigite may, therefore, contribute to the observed increase in compressive strength of clinker A during curing.

The composition of the cement clinker may vary according to the raw materials incorporated and heat treatment of the raw materials during calcination. In one embodiment, the cement clinker may comprise calcium magnesium silicate phases, including bredigite, merwinite and åkermanite-gehlenite solid solutions, of at least 10% by weight. In another embodiment, the cement clinker may comprise at least 30% by weight of magnesium silicate phases. In yet another embodiment, the cement clinker may comprise at least 10% by weight of bredigite and at least 1% by weight of merwinite.

A content of magnesium oxide in the cement clinker may be less than 5% by weight, in one embodiment. In another embodiment, an absolute level of magnesium in the cement clinker that is represented as magnesium oxide, in the cement clinker may range from 4% to 16% by weight. In another embodiment, the absolute level of magnesium represented as magnesium oxide may range from 4% to 12% by weight and, in yet another embodiment, may range from 4% to 10% by weight.

Further, in one embodiment, the clinker may have a ratio of ye'elimite:clinker phases (e.g., all phases present in the clinker) of >35%. In another embodiment, the clinker may have a ratio of belite:clinker phases of <40%. In yet another embodiment, the ratio of belite:clinker phases may be 40% or higher when the ratio of ye'elimite:clinker phases is >35%. Further, to obtain ratios of belite:clinker phases of >40%, raw materials with low iron and magnesium content may be demanded.

A cement clinker comprising calcium magnesium silicates is thereby produced as described herein. Relative to other cement clinkers, including clinkers for CSA cement and Portland cement, an increased amount of industrial byproducts, particularly byproducts comprising magnesium compounds, may be used to form the calcium magnesium silicate phases in the cement clinker. The relatively high magnesium content of the clinker does not demonstrate loss of strength and may exhibit continuous strength development with reaction time duration. The formation of calcium magnesium silicates in the cement clinker without loss of strength observed in the resulting cement enables more industrial byproducts to be used for cement production with concomitant reduction in carbon emissions.

Embodiments of the present disclosure can be described in view of the following clauses:
1. A cementitious mixture, comprising:
calcium magnesium silicates at a concentration of at least 10% by weight.
2. The cementitious mixture of clause 1, further comprising a ratio of ye'elimite to all clinker phases present in the cementitious mixture of at least 35%.
3. The cementitious mixture of any one of clauses 1 or 2, further comprising a ratio of belite to all clinker phases present in the cementitious mixture of less than 40%.
4. The cementitious mixture of any one of clauses 1-3, further comprising a ratio of belite to all clinker phases present in the cementitious mixture of greater than 40% when a ratio of ye'elimite to all clinker phases present in the cementitious mixture is at least 35%.
5. The cementitious mixture of any of clauses 1-4, wherein the calcium magnesium silicates comprise one or more of bredigite or merwinite.
6. The cementitious mixture of any of clauses 1-6, wherein the calcium magnesium silicates comprise åkermanite-gehlenite solid solutions.
7. The cementitious mixture of any of clauses 1-7, wherein the cementitious mixture comprises at least 20% of the calcium magnesium silicates by weight.
8. The cementitious mixture of any of clauses 1-8, wherein the cementitious mixture comprises at least 30% of the calcium magnesium silicates by weight.
9. The cementitious mixture of any of clauses 1-9, wherein the cementitious mixture is formed of at least 60% by weight of industrial byproducts.
10. The cementitious mixture of any of clauses 1-10, wherein the cementitious mixture is formed of at least 90% by weight of industrial byproducts.
11. A method for cement clinker production, comprising:
heating a mixture comprising at least 70% by weight of industrial byproducts;
forming calcium magnesium silicate phases in the mixture during the heating; and
cooling the mixture to obtain a cement clinker.
12. The method of clause 11, wherein the mixture comprises greater than 90% by weight of the industrial byproducts.
13. The method of any of clauses 11 or 12, wherein heating the mixture includes forming a liquid phase in the mixture.
14. The method of any of clauses 11-13, wherein the mixture is heated to a temperature range of 1220° C. to 1280° C.
15. A calcium sulfoaluminate (CSA) cement clinker, comprising:
at least 10% by weight of calcium magnesium silicates; and
a ratio of ye'elimite to all cement clinker phases of greater than 35%,
16. The CSA cement clinker of clause 15, further comprising greater than 70% by weight of metallurgical and mining slags.
17. The CSA cement clinker of any of clauses 15 or 16, wherein the cement clinker comprises alite.
18. The CSA cement clinker of any of clauses 15-17, further comprising less than 5% by weight of magnesium oxide.
19. The CSA cement clinker of any of clauses 15-18, wherein a compressive strength of the CSA cement clinker increases with reaction time beyond 28 days of standard curing.
20. The CSA cement clinker of any of clauses 15-19, further comprising an absolute level of magnesium represented as magnesium oxide MgO in the clinker ranging from 4% to 16%, preferentially 4% to 12% and more preferentially 4% to 10%.

The specification and drawings are to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

All references including publications, patent applications, and patents cited herein are hereby incorporated by reference to the same extent as if each reference were individually and specifically indicated to be incorporated by reference and were set forth in its entirety herein.

What is claimed is:

1. A cementitious mixture, comprising:
calcium magnesium silicates at a concentration of at least 10% by weight.

2. The cementitious mixture of claim 1, further comprising a ratio of ye'elimite to all clinker phases present in the cementitious mixture of at least 35%.

3. The cementitious mixture of claim 1, further comprising a ratio of belite to all clinker phases present in the cementitious mixture of less than 40%.

4. The cementitious mixture of claim 1, further comprising a ratio of belite to all clinker phases present in the cementitious mixture of greater than 40% when a ratio of ye'elimite to all clinker phases present in the cementitious mixture is at least 35%.

5. The cementitious mixture of claim 1, wherein the calcium magnesium silicates comprise one or more of bredigite or merwinite.

6. The cementitious mixture of claim 1, wherein the calcium magnesium silicates comprise åkermanite-gehlenite solid solutions.

7. The cementitious mixture of claim 1, wherein the cementitious mixture comprises at least 20% of the calcium magnesium silicates by weight.

8. The cementitious mixture of claim 1, wherein the cementitious mixture comprises at least 30% of the calcium magnesium silicates by weight.

9. The cementitious mixture of claim 1, wherein the cementitious mixture is formed of at least 60% by weight of industrial byproducts.

10. The cementitious mixture of claim 1, wherein the cementitious mixture is formed of at least 90% by weight of industrial byproducts.

11. A method for cement clinker production, comprising:
heating a mixture comprising at least 70% by weight of industrial byproducts;
forming calcium magnesium silicate phases in the mixture during the heating; and
cooling the mixture to obtain a cement clinker.

12. The method of claim 11, wherein the mixture comprises greater than 90% by weight of the industrial byproducts.

13. The method of claim 11, wherein heating the mixture includes forming a liquid phase in the mixture.

14. The method of claim 11, wherein the mixture is heated to a temperature range of 1220° C. to 1280° C.

15. A calcium sulfoaluminate (CSA) cement clinker, comprising:
at least 10% by weight of calcium magnesium silicates; and
a ratio of ye'elimite to all cement clinker phases of greater than 35%.

16. The CSA cement clinker of claim 15, further comprising greater than 70% by weight of metallurgical and mining slags.

17. The CSA cement clinker of claim 15, wherein the cement clinker comprises alite.

18. The CSA cement clinker of claim 15, further comprising less than 5% by weight of magnesium oxide.

19. The CSA cement clinker of claim 15, wherein a compressive strength of the CSA cement clinker increases with reaction time beyond 28 days of standard curing.

20. The CSA cement clinker of claim 15, further comprising an absolute level of magnesium represented as magnesium oxide MgO in the clinker ranging from 4% to 16%, preferentially 4% to 12% and more preferentially 4% to 10%.
